(19) United States
(12) Patent Application Publication
(10) Pub. No.: US 2026/0356172 A1
(43) Pub. Date: Nov. 12, 2026

(54) AIR-CONDITIONING REGISTER

(71) Applicant: TOYODA GOSEI CO., LTD., Kiyosu-shi (JP)

(72) Inventor: Hironori TAKAGI, Kiyosu-shi (JP)

(21) Appl. No.: 19/652,310

(22) Filed: Apr. 20, 2026

(30) Foreign Application Priority Data
May 9, 2025 (JP) 2025-078689

(51) Int. Cl. B60H 1/34

(52) U.S. Cl. CPC B60H 1/3421; B60H 2001/3478

(57) ABSTRACT

An air-conditioning register includes a retainer, a shut damper, fins, an operation knob, and a transmission mechanism. The transmission mechanism includes a tilting portion configured to tilt together with the fins in conjunction with movement of the operation knob in an operating direction of the operation knob between a first tilting position and a third tilting position, with a second tilting position interposed therebetween, and a conversion mechanism portion configured to convert tilting of the tilting portion into tilting of the shut damper only when the tilting portion tilts between the second tilting position and the third tilting position.

### CROSS-REFERENCE TO RELATED APPLICATIONS

This application is based upon and claims the benefit of priority from Japanese Patent Application No. 2025-078689, filed on May 9, 2025, the entire contents of which are incorporated herein by reference.

### BACKGROUND

### 1. Field

The present disclosure relates to an air-conditioning register provided with a shut damper.

### 2. Description of Related Art

JP2020-50137A discloses an air-conditioning register provided with a retainer, a shut damper, fins, and an operation knob. The retainer is tubular and has a passage for conditioned air. The passage has an air outlet at its downstream end. The shut damper is disposed within the retainer and tilts about its damper shaft between an open position, in which the passage is opened, and a closed position, in which the passage is closed. The fins are disposed inside the retainer and downstream of the shut damper. By tilting about respective fin shafts, the fins change the direction of the flow of the conditioned air. The operation knob is operated to actuate the shut damper and the fins.

The operation knob includes a slidable knob body, a rotary portion rotatably mounted on the knob body, a transmission shaft connected to the rotary portion so as to transmit rotation, and a rotation-direction conversion mechanism that converts rotation of the transmission shaft into opening and closing of the shut damper.

In the above air-conditioning register, sliding of the operation knob tilts the fins. As the conditioned air flows along the fins, the discharge direction of the conditioned air from the air outlet changes.

Further, when the rotary portion is rotated, the transmission shaft is rotated. This rotation is converted by the rotation-direction conversion mechanism into opening and closing of the shut damper. The shut damper tilts about the damper shaft between the open position and the closed position. When the shut damper is tilted to the closed position, discharge of the conditioned air from the air outlet is blocked.

However, in the air-conditioning register disclosed in the above publication, the user slides the operation knob in order to tilt the fins, and rotates the rotary portion of the operation knob in order to tilt the shut damper. Thus, different types of operations need to be performed on the same operation knob depending on whether the fins or the shut damper are to be tilted. As a result, operation of the operation knob is confusing for the user. Accordingly, the air-conditioning register disclosed in the above publication still has room for improvement in terms of operability of the operation knob.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An air-conditioning register according to an aspect of the present disclosure includes a retainer including a passage for conditioned air. The passage includes an air outlet at a downstream end of the passage. The air-conditioning register includes a shut damper including a damper body disposed in the retainer and a damper shaft supported by the retainer and supporting the damper body. The damper body is configured to tilt about the damper shaft between an open position in which the passage is opened and a closed position in which the passage is closed. The air-conditioning register includes fins, each including a fin body disposed in the retainer and downstream of the damper body in the passage and a fin shaft supported by the retainer and supporting the fin body. The fin is configured to change a flow direction of the conditioned air by the fin body tilting about the fin shaft. The air-conditioning register includes an operation knob configured to be operated to tilt the fins. The air-conditioning register includes a transmission mechanism configured to transmit tilting of the fins to the shut damper. The transmission mechanism includes a tilting portion configured to tilt together with the fins in conjunction with movement of the operation knob in an operating direction of the operation knob between a first tilting position and a third tilting position, with a second tilting position interposed therebetween, and a conversion mechanism portion configured to convert tilting of the tilting portion into tilting of the shut damper only when the tilting portion tilts between the second tilting position and the third tilting position.

Other features and aspects will be apparent from the following detailed description, the drawings, and the claims.

### BRIEF DESCRIPTION OF THE DRAWINGS

FIG. 1 is a perspective view of an air-conditioning register according to an embodiment.

FIG. 2 is a front view of the air-conditioning register in the embodiment.

FIG. 3 is a side sectional view of the air-conditioning register in the embodiment.

FIG. 4 is a plan sectional view of the air-conditioning register in the embodiment.

FIG. 5 is a perspective view showing some components extracted from the air-conditioning register of FIG. 1.

FIG. 6 is also a perspective view showing some components extracted from the air-conditioning register of FIG. 1.

FIG. 7 is a partial perspective view showing part of the upstream fins and part of the transmission mechanism extracted from the air-conditioning register of FIG. 1.

FIG. 8 is a perspective view showing the upstream fins after being tilted by sliding the operation knob of FIG. 6 leftward.

FIG. 9 is a perspective view showing the upstream fins tilted to a position that closes the passage by further sliding the operation knob of FIG. 8 leftward.

FIG. 10 is a bottom view showing the transmission mechanism, the upstream fins, and other components extracted from the air-conditioning register in which the upstream fins are in the neutral position, according to the embodiment.

FIG. 11 is a bottom view showing the transmission mechanism, the upstream fins, and other components extracted from the air-conditioning register with the tilting portion in the second tilting position, according to the embodiment.

FIG. 12 is a bottom view showing the transmission mechanism, the upstream fins, and other components extracted from the air-conditioning register in which the tilting portion in the third tilting position, according to the embodiment.

FIG. 13 is a partial side view of the air-conditioning register when the shut damper is in the open position, according to the embodiment.

FIG. 14 is a partial side view of the air-conditioning register when the shut damper is in the closed position, according to the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An air-conditioning register for a vehicle according to an embodiment of the present disclosure will now be described with reference to the drawings.

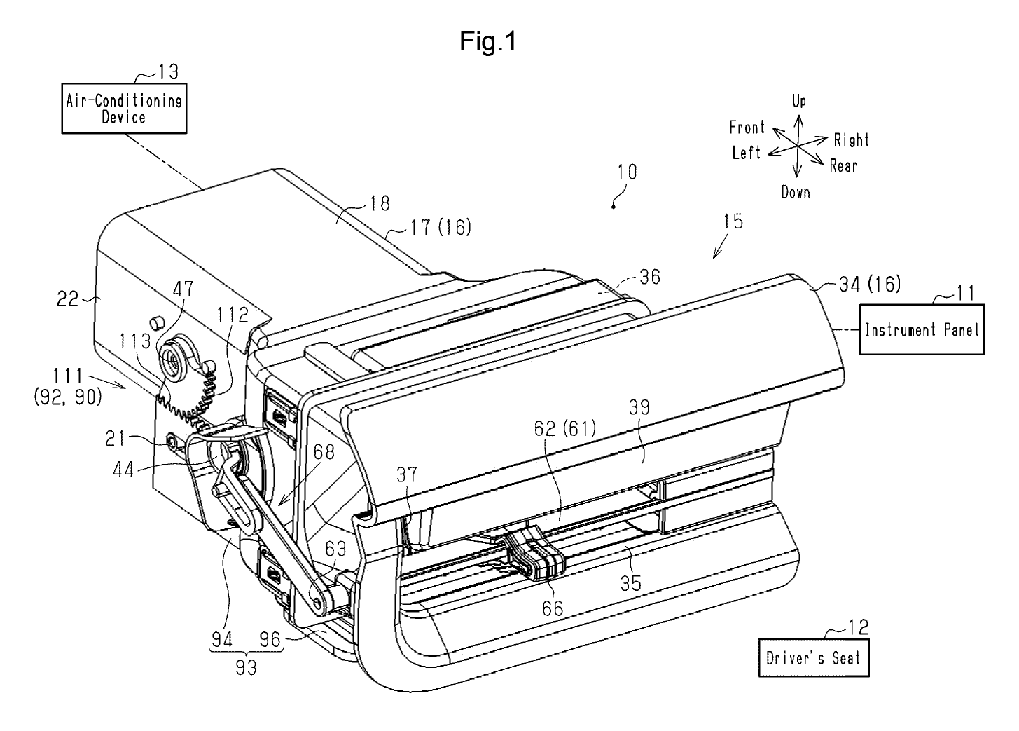

As shown in FIG. 1, an instrument panel 11 is provided in a vehicle interior of a vehicle 10 in front of a front seat. An air-conditioning register 15 is incorporated in, for example, a central portion or a side portion of the instrument panel 11 in a left-right direction. In the present embodiment, the air-conditioning register 15 is incorporated in front of a driver’s seat 12 of a left-hand-drive vehicle.

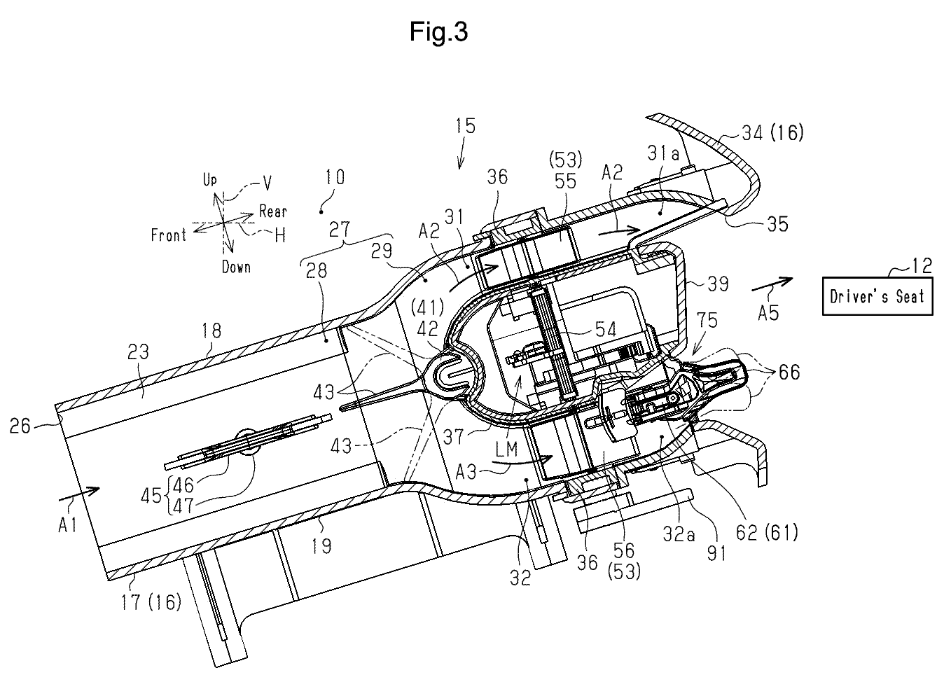

As shown in FIGS. 3-5, the air-conditioning register 15 includes a retainer 16, a distribution member 41, a shut damper 45, two shims 36, upstream fins 51 to 53, a downstream fin 61, an operation knob 66, a linkage mechanism 68, a drive mechanism 75, and a second transmission mechanism 90. Each of the upstream fins 51 to 53 is an example of a fin. The second transmission mechanism 90 is an example of a transmission mechanism. Each component of the air-conditioning register 15 will now be described in detail.

### Retainer 16 and Inner Member 37

Referring to FIG. 1, the retainer 16 connects a ventilation duct (not shown) of the air-conditioning device 13 to an opening (not shown) provided in the instrument panel 11. The retainer 16 includes a retainer body 17 and a bezel 34.

As shown in FIGS. 1, 3, and 4, the retainer body 17 has a passage 27 for conditioned air A1 to A4. The passage 27 is inclined with respect to a horizontal plane H, rising toward the rear of the vehicle 10. In the present specification, the passage 27 serves as a reference for describing components of the air-conditioning register 15. The direction in which the passage 27 extends is referred to as a front-rear direction. Two directions that are orthogonal to the front-rear direction and orthogonal to each other are defined such that one direction is an up-down direction and the other direction is a left-right direction. The up-down direction of the air-conditioning register 15 is slightly inclined with respect to a vertical plane V.

The conditioned air A1 to A4 flows through the passage 27 from the front (upstream) toward the rear (downstream). The retainer body 17 has a tubular shape, with its upstream and downstream ends being open. The upstream end of the retainer body 17 serves as an inlet 26 for the conditioned air A1.

The bezel 34 forms a most downstream portion of the retainer 16, and is attached to the retainer body 17. The bezel 34 has an air outlet 35, from which conditioned air A5 is discharged, at a portion corresponding to a downstream end of the passage 27. A portion of the bezel 34 surrounding the air outlet 35 forms part of a design surface of the air-conditioning register 15.

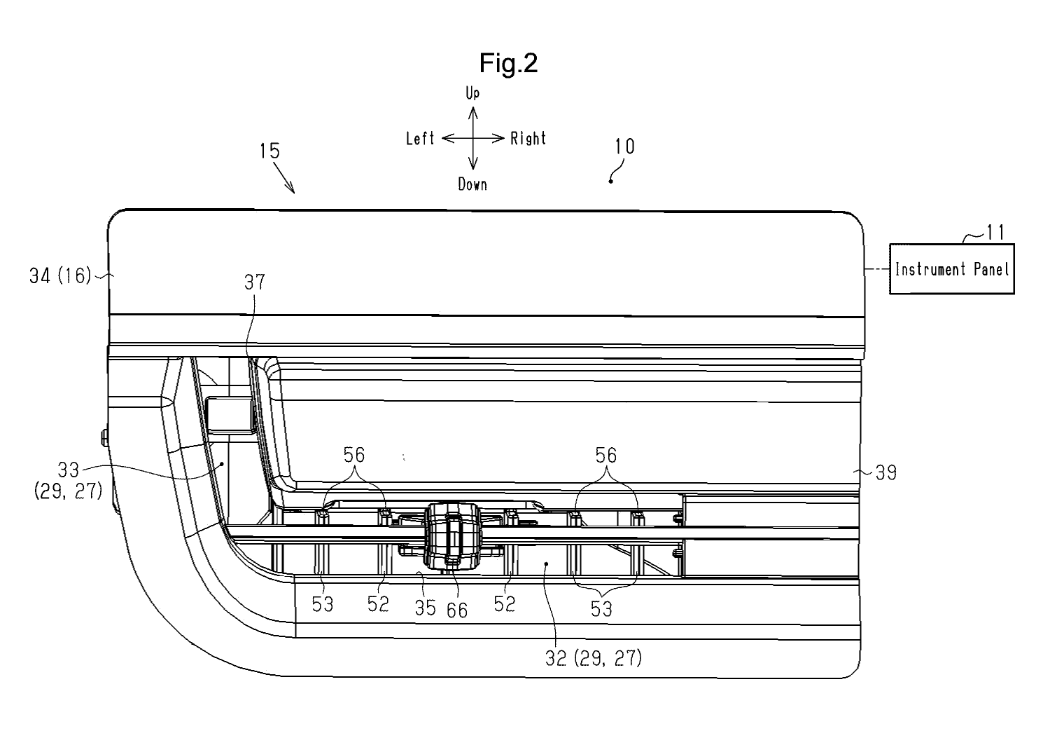

As shown in FIGS. 2-4, the passage 27 includes an upstream passage portion 28 and a downstream passage portion 29, which is connected to the upstream passage portion 28 on its downstream side. The downstream passage portion 29 includes two body passage portions 31, 32 and a connecting passage portion 33.

The retainer body 17 includes an upper wall 18 and a lower wall 19 facing each other in the up-down direction, and two side walls 22, 23 facing each other in the left-right direction. The upper wall 18, the lower wall 19, and the two side walls 22 and 23 each have straight portions extending along the passage 27 at upstream and downstream portions thereof.

In describing components of the air-conditioning register 15, a direction in the thickness direction of the retainer body 17 away from the passage 27 may be referred to as terms such as “outward” or “outside.”

The inner member 37 is located downstream of the upstream passage portion 28 in the retainer body 17. Of the retainer body 17, the inner member 37 is in contact with only the side wall 23. The inner member 37 protrudes from the side wall 23 toward the side wall 22. The right end of the inner member 37 is attached to the right side wall 23. The inner member 37 includes a protruding end surface 38 that is spaced apart from the left side wall 22 rightward.

A decorative panel 39 extending in the left-right direction is disposed downstream of the inner member 37 and downstream of the right side wall 23. The decorative panel 39 is attached to each of the inner member 37 and the right side wall 23. The decorative panel 39 has a downstream end surface that forms part of the design surface of the air-conditioning register 15.

The downstream passage portion 29 is located between the retainer body 17 and the inner member 37. The retainer body 17 includes the two body passage portions 31, 32 on opposite sides of the inner member 37 in the up-down direction. The body passage portion 31 is located between the inner member 37 and the upper wall 18. The body passage portion 32 is located between the inner member 37 and the lower wall 19.

The connecting passage portion 33 is located between the protruding end surface 38 of the inner member 37 and the left side wall 22. The connecting passage portion 33 connects the two body passage portions 31, 32 to each other. The two body passage portions 31, 32 and the connecting passage portion 33 lead to the air outlet 35. The two body passage portions 31, 32 and the connecting passage portion 33 branch, on the upstream side of the inner member 37, from the upstream passage portion 28.

The conditioned air A2 flowing through the upper body passage portion 31, the conditioned air A3 flowing through the lower body passage portion 32, and the conditioned air A4 flowing through the connecting passage portion 33 are mixed and discharged from the air outlet 35.

The retainer 16 is configured such that the conditioned air A2 and the conditioned air A3 meet. The downstream portions 31a, 32a of the two body passage portions 31, 32 are inclined with respect to the extending direction of the passage 27 (i.e., the front-rear direction) such that the downstream portions 31a, 32a approach each other toward the air outlet 35.

### Distribution Member 41

As shown in FIGS. 3-5, the distribution member 41 is disposed inside the retainer body 17 in the region where the two body passage portions 31 and 32 branch, adjacent to the inner member 37 on the upstream side. The distribution member 41 includes a rotating base 42 extending in the left-right direction and a flat distribution body 43 radially protruding outward from the rotating base 42. Distribution shafts 44 are provided on the opposite sides of the rotating base 42 in the left-right direction, respectively. The distribution member 41 is supported by the two distribution shafts 44 to be vertically tiltable with respect to the side walls 22, 23.

The distribution member 41 tilts to distribute some of the conditioned air A1 flowing through the upstream passage portion 28 to the two body passage portions 31, 32. In other words, the distribution member 41 changes the ratio between the conditioned air A2, which flows through the upper body passage portion 31, and the conditioned air A3, which flows through the lower body passage portion 32.

### Shut Damper 45

The shut damper 45 includes a flat damper body 46 disposed in the upstream passage portion 28. The shut damper 45 also includes two damper shafts 47 provided at the opposite side edges of the damper body 46 in the left-right direction. The shut damper 45 is supported on the side walls 22, 23 by the two damper shafts 47 so as to be tiltable between an open position and a closed position.

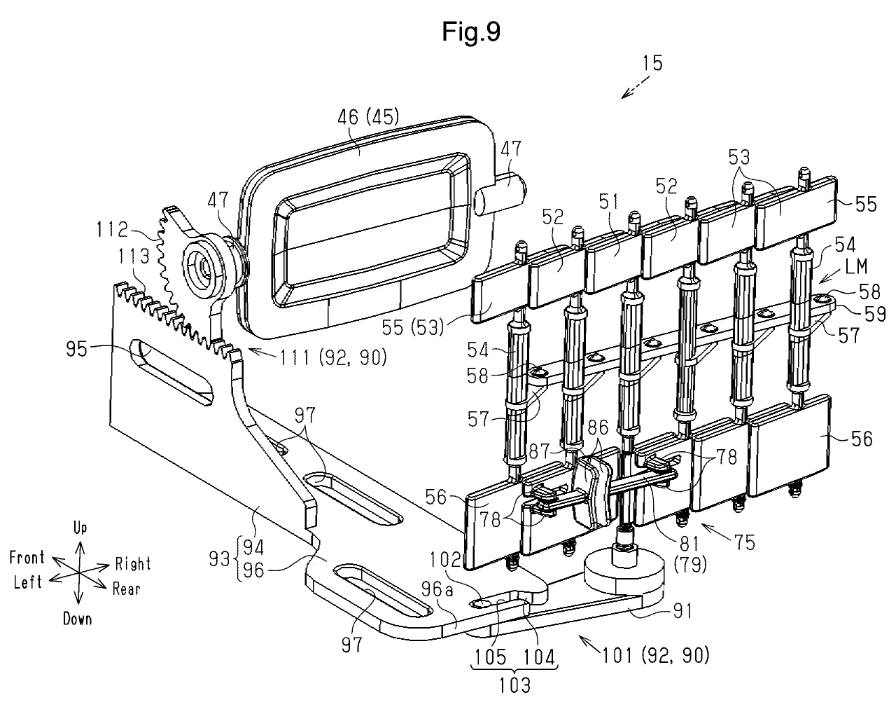

In the open position, as indicated by broken lines in FIGS. 3, 5, and 13, the damper body 46 is parallel or substantially parallel to the upstream portions of the upper wall 18 and the lower wall 19, and creates a relatively large opening to the upstream passage portion 28. In the closed position, as shown by broken lines in FIGS. 9 and 14, the damper body 46 tilts while being substantially orthogonal to the upstream portions of the upper wall 18 and the lower wall 19, and closes the upstream passage portion 28.

### Shim 36

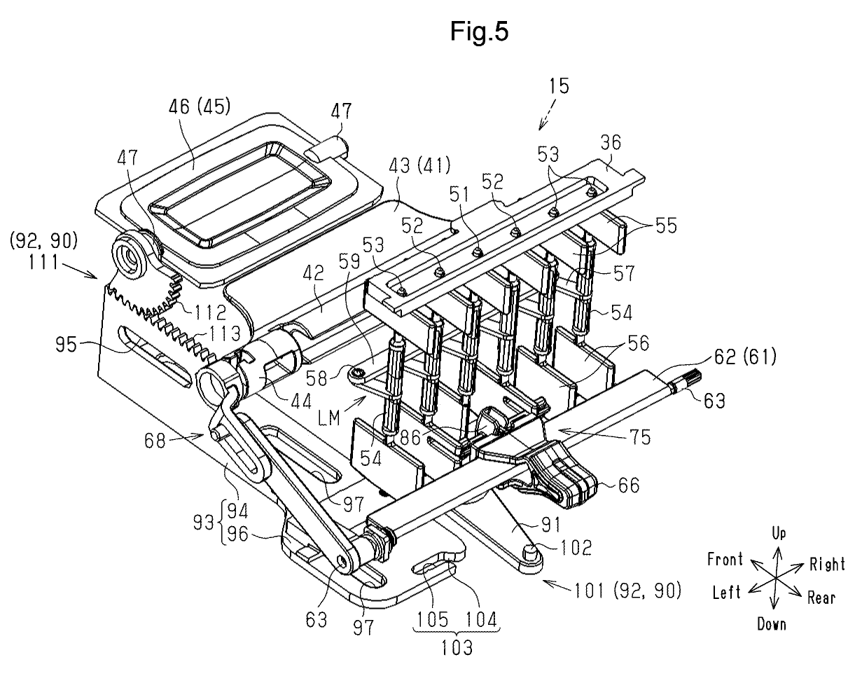

As shown in FIGS. 3 and 5, the air-conditioning register 15 includes two flat shims 36. The upper shim 36 is attached to the upper wall 18. The lower shim 36 is attached to the lower wall 19. In FIG. 5, the lower shim 36 is not shown.

### Upstream Fins

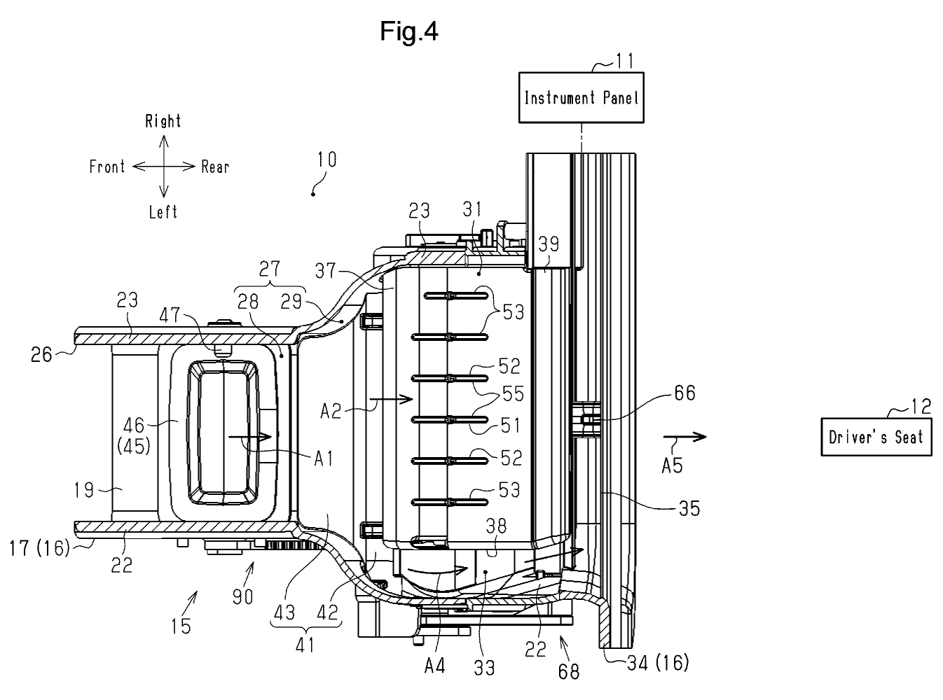

As shown in FIGS. 4 and 5, multiple (six in the present embodiment) upstream fins include the following three types of upstream fins 51, 52, 53.
One upstream fin 51 disposed at the center in the left-right direction
Two upstream fins 52 disposed on the opposite sides of the upstream fin 51 in the left-right direction
The remaining three upstream fins 53

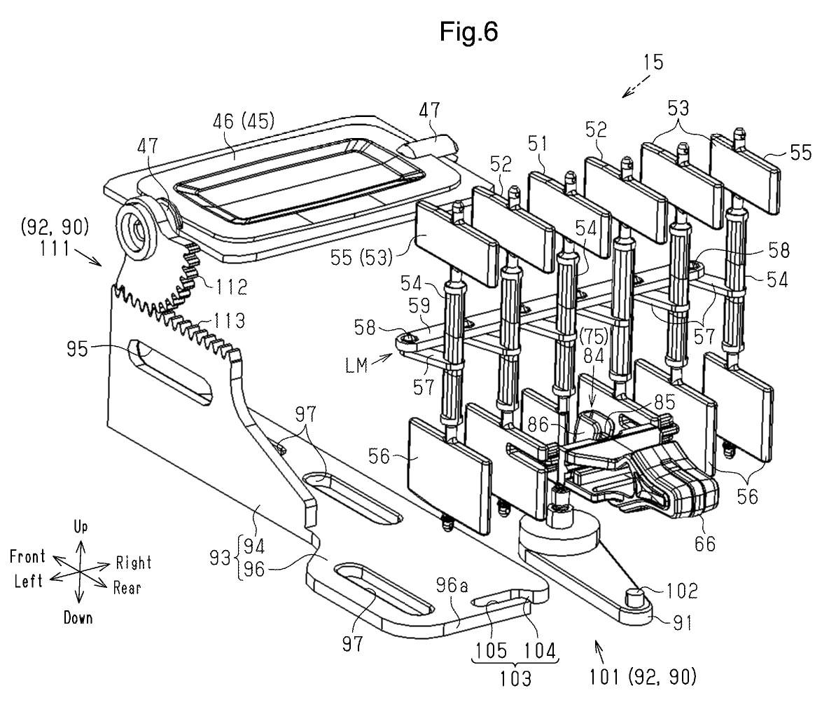

As shown in FIGS. 3 and 5, each of the upstream fins 51 to 53 includes an upstream fin shaft 54 extending in the up-down direction, unlike the damper shaft 47 extending in the left-right direction. Each of the upstream fin shafts 54 is an example of a fin shaft. The upstream fin shafts 54 are spaced apart from each other in the left-right direction. An intermediate portion of each upstream fin shaft 54 in the up-down direction is inserted through the inner member 37 (see FIG. 3). The upper end of each upstream fin shaft 54 is rotatably supported by the upper shim 36. The lower end of each upstream fin shaft 54 is inserted through the lower shim 36. The lower end of the upstream fin shaft 54 of the upstream fin 51 is positioned below the lower shim 36 (see FIG. 6). The lower end of the upstream fin shaft 54 is rotatably supported by the lower shim 36 at a portion of the lower end inserted through the lower shim 36.

Each upstream fin shaft 54 includes a flat upper upstream fin body 55 at a portion between the upper wall 18 and the inner member 37. The upstream fin shaft 54 and the upper upstream fin body 55 are integrally rotatable. The central portion of each upstream fin body 55 in the front-rear direction is connected to a corresponding upstream fin shaft 54. Each upstream fin shaft 54 includes a flat lower upstream fin body 56 at a portion between the lower wall 19 and the inner member 37. The upstream fin shaft 54 and the upper upstream fin body 56 are integrally rotatable. The upstream fin body 55 is an example of a fin body.

The lower upstream fin body 56 of the upstream fin 51 has a smaller dimension in the front-rear direction than the lower upstream fin body 56 of each of the upstream fins 52, 53. The downstream end of the upstream fin body 55 is connected to the upstream fin shaft 54. Accordingly, in the upstream fin 51, the upstream fin body 56 is not located downstream of the upstream fin shaft 54. The upstream fin body 56 of each of the upstream fins 52, 53 is connected to a corresponding upstream fin shaft 54 at the central portion of the upstream fin body 56 in the front-rear direction.

As shown in FIGS. 5 and 6, a connecting arm 57 protruding radially outward is provided at a portion of each upstream fin shaft 54 inserted into the inner member 37. A connecting shaft 58 protruding upward is provided at a protruding end of the connecting arm 57 of each of the upstream fins 51 to 53. The connecting shafts 58 of the connecting arms 57 are connected by a connecting rod 59 extending in the left-right direction. All of the connecting shafts 58 and the connecting rods 59 form a link mechanism LM. The link mechanism LM tilts all of the upstream fins 51 to 53 synchronously such that they are inclined in the same direction.

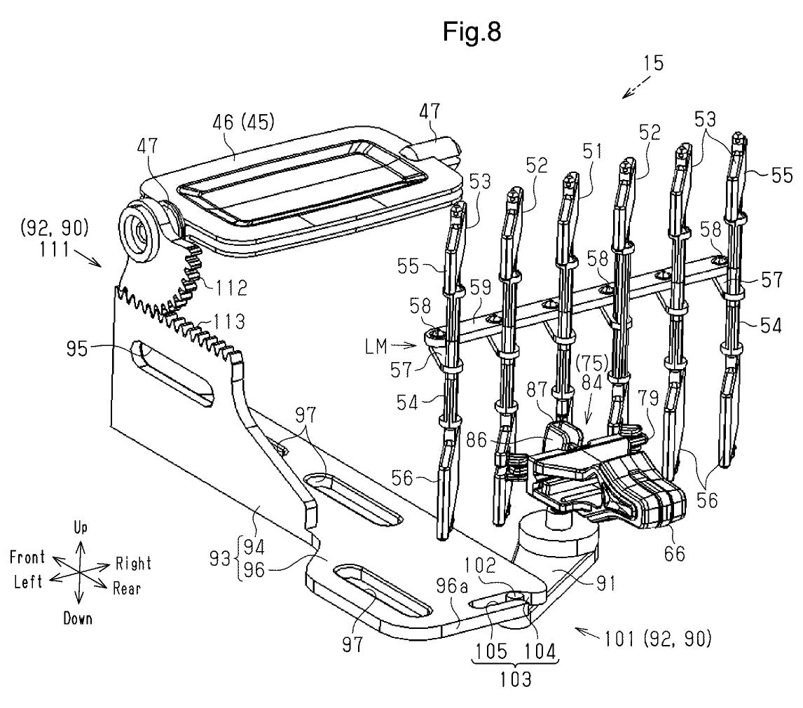

As shown in FIGS. 6 and 8, each of the upstream fins 51 to 53 having the above configuration changes the discharge direction of the conditioned air A5 from the air outlet 35 to the left-right direction, by tilting in the left-right direction about the upstream fin shaft 54. In addition, as shown in FIG. 9, the upstream fins 51 to 53 are configured to close the two body passage portions 31, 32. The closing of the upstream fins 51 to 53 prevents the conditioned air A2, A3 from flowing downstream of the upstream fin bodies 55, 56 in the body passage portions 31, 32.

### Downstream Fin 61

As shown in FIGS. 3 and 5, the downstream fin 61 includes a flat downstream fin body 62 and two downstream fin shafts 63 provided on the opposite side edges of the downstream fin body 62 in the left-right direction. The downstream fin 61 is supported on the side walls 22, 23 by the two downstream fin shafts 63. The downstream fin 61 changes the flow direction of the conditioned air A3 in the up-down direction in the lower body passage portion 32, by vertically tilting about the downstream fin shafts 63.

### Operation Knob 66

The operation knob 66 is operated by a vehicle occupant to, for example, change the discharge direction of the conditioned air A5 from the air outlet 35 or block discharge of the conditioned air A5 from the air outlet 35. In other words, the operation knob 66 is operated to tilt the upstream fin body 55, 56 of each of the upstream fins 51 to 53 and tilt the downstream fin 61. The operation knob 66 is attached to the downstream fin body 62 to be slidable in the left-right direction. The operation knob 66 is vertically tiltable together with the downstream fin 61 about the two downstream fin shafts 63.

### Linkage Mechanism 68

The linkage mechanism 68 tilts the distribution member 41 in conjunction with tilting of the downstream fin 61 by transmitting rotation of the downstream fin shaft 63 to the distribution member 41. The linkage mechanism 68 is located between the downstream fin shafts 63 and the distribution shaft 44. The linkage refers to tilting, when the downstream fin 61 is vertically tilted, the distribution member 41 in a direction opposite to the tilting direction of the downstream fin 61.

### Drive Mechanism 75

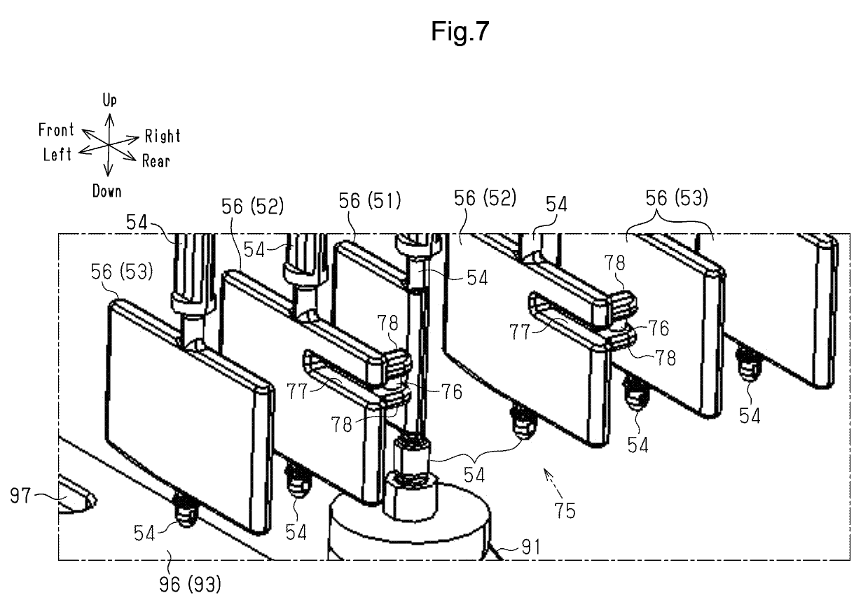

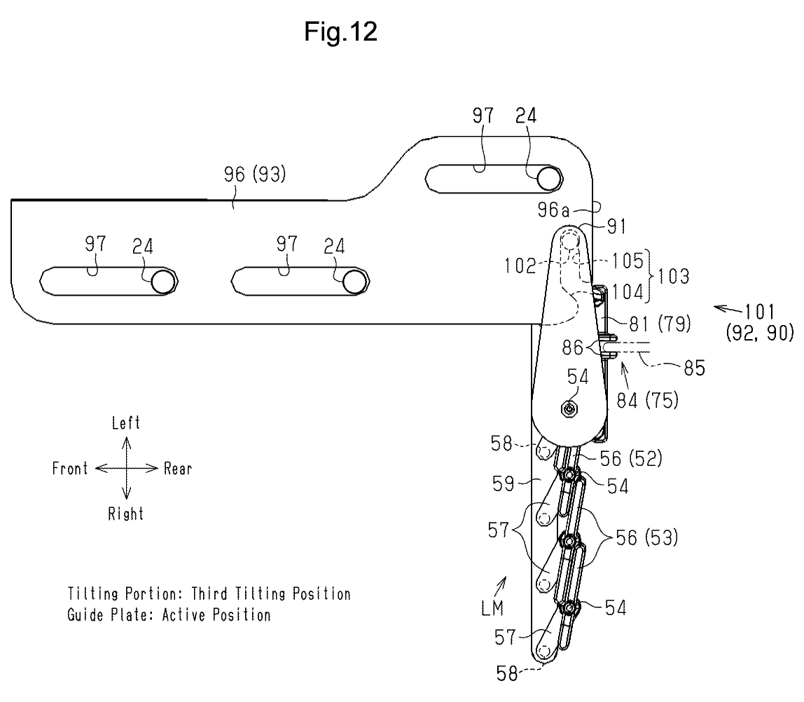

As shown in FIGS. 7, 9, and 12, the drive mechanism 75 tilts the upstream fins 51 to 53 in conjunction with sliding of the operation knob 66 in the left-right direction. The drive mechanism 75 includes two connecting shafts 76 (see FIG. 7), a rod 79, and a first transmission mechanism 84 (see FIG. 12). The two connecting shafts 76 are provided on the lower upstream fin bodies 56 of the two upstream fins 52, respectively.

As shown in FIG. 7, each connecting shaft 76 is located downstream of a corresponding upstream fin shaft 54 of the upstream fin body 56 and rightward from the upstream fin body 56. Specifically, each upstream fin body 56 has a notch 77 extending upstream from the downstream end thereof. Each notch 77 is sized to allow a rod body 81 of the rod 79 to pass through the notch 77.

At the downstream end of each upstream fin body 56, support protrusions 78 protruding rightward are provided above and below the notch 77. The connecting shaft 76 of each upstream fin 52 extends between the two support protrusions 78.

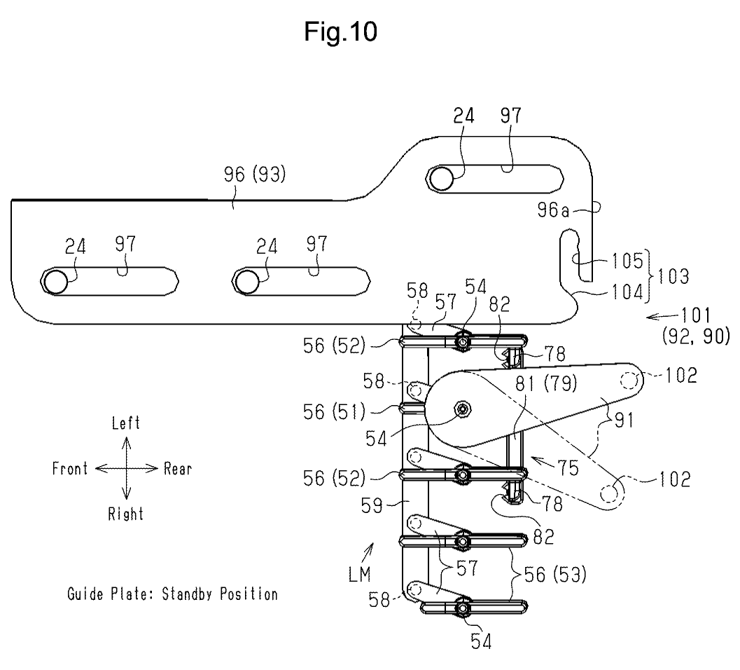

As shown in FIG. 9, the rod 79 includes the rod body 81, which is flat and extends in the left-right direction. Shaft support portions 82 (see FIG. 10) are provided at upstream portions of the opposite ends of the rod body 81 in the left-right direction. Each shaft support portion 82 includes a recess that is recessed from the upstream end surface of the rod body 81 toward the downstream side.

The connecting shafts 76 of the upstream fins 52 (see FIG. 7) are engaged with the shaft support portions 82, so that the rod 79 is connected to the two connecting shafts 76.

As shown in FIGS. 6 and 12, the first transmission mechanism 84 moves the rod 79 in the left-right direction by transmitting sliding of the operation knob 66 to the rod 79. The first transmission mechanism 84 includes one flat first rib 85 and two flat second ribs 86. The first rib 85 protrudes upstream from the operation knob 66.

As shown in FIGS. 8 and 9, the two second ribs 86 are located at an intermediate portion of the rod body 81 in the left-right direction and spaced apart from each other in the same direction. Upstream ends of the second ribs 86 are connected to each other by a flat connecting plate portion 87. The two second ribs 86 sandwich the first rib 85 from the opposite sides in the left-right direction (see FIG. 12).

### Second Transmission Mechanism 90

Referring to FIG. 6, the second transmission mechanism 90 transmits tilting of the upstream fins 51 to 53 to the shut damper 45. The second transmission mechanism 90 includes a tilting portion 91 and a conversion mechanism portion 92.

The tilting portion 91 tilts in the left-right direction together with the upstream fin 51 in conjunction with movement of the operation knob 66 in its operation direction. As described above, the lower end of the upstream fin shaft 54 of the upstream fin 51 protrudes downward from the lower shim 36. The tilting portion 91 is attached to a projection of the upstream fin shaft 54 so as to be integrally rotatable. The tilting portion 91 protrudes radially outward from the upstream fin shaft 54.

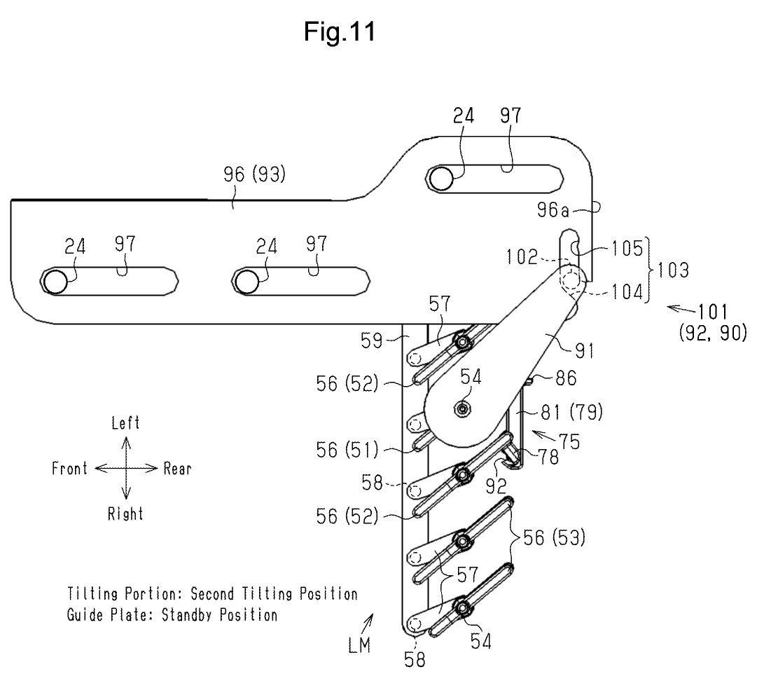

The tilting portion 91 is configured to tilt between a first tilting position, indicated by a double-dashed line in FIG. 10, and a third tilting position, indicated in FIG. 12, as the upstream fin shaft 54 rotates. When tilting from the first tilting position to the third tilting position or vice versa, the tilting portion 91 passes through a second tilting position shown in FIG. 11, which is defined between the first tilting position and the third tilting position.

As indicated by the double-dashed line in FIG. 10, when in the first tilting position, the tilting portion 91 is tilted with respect to the front-rear direction such that its downstream end is positioned rightward. As shown in FIGS. 8 and 11, when in the second tilting position, the tilting portion 91 is tilted with respect to the front-rear direction such that its downstream end is positioned leftward. As shown in FIGS. 9 and 12, when in the third tilting position, the tilting portion 91 extends in the left-right direction.

The tilting portion 91 is configured to be in the third tilting position when the upstream fins 51 to 53 are positioned such that the upper and lower body passage portions 31 are closed (see FIG. 12).

When the tilting portion 91 is in the first tilting position, the conversion mechanism portion 92 places the shut damper 45 in the open position. As shown in FIG. 9, when the tilting portion 91 is in the third tilting position, the conversion mechanism portion 92 places the shut damper 45 in the closed position.

When the tilting portion 91 tilts between the second tilting position and the third tilting position, the conversion mechanism portion 92 converts tilting of the tilting portion 91 into tilting of the shut damper 45.

The conversion mechanism portion 92 switches, when the tilting portion 91 passes through the second tilting position (see FIG. 11) during tilting from the first tilting position to the third tilting position, from a state in which tilting of the tilting portion 91 is not converted into tilting of the shut damper 45 to a state in which tilting of the tilting portion 91 is converted into tilting of the shut damper 45.

The conversion mechanism portion 92 switches, when the tilting portion 91 passes through the second tilting position (see FIG. 11) during tilting from the third tilting position to the first tilting position, from the state in which tilting of the tilting portion 91 is converted into tilting of the shut damper 45 to the state in which tilting of the tilting portion 91 is not converted into tilting of the shut damper 45.

The conversion mechanism portion 92 includes a guide plate 93, a first conversion mechanism portion 101, and a second conversion mechanism portion 111.

### Guide Plate 93

As shown in FIGS. 1 and 6, the guide plate 93 is disposed between the tilting portion 91 and the damper shaft 47 so as to be linearly movable in the front-rear direction. The guide plate 93 includes a flat vertical guide plate portion 94 and a flat horizontal guide plate portion 96.

The vertical guide plate portion 94 is disposed on the left of the side wall 22. The horizontal guide plate portion 96 is disposed below the lower wall 19. The left side edge of the horizontal guide plate portion 96 is connected to the lower edge of the vertical guide plate portion 94.

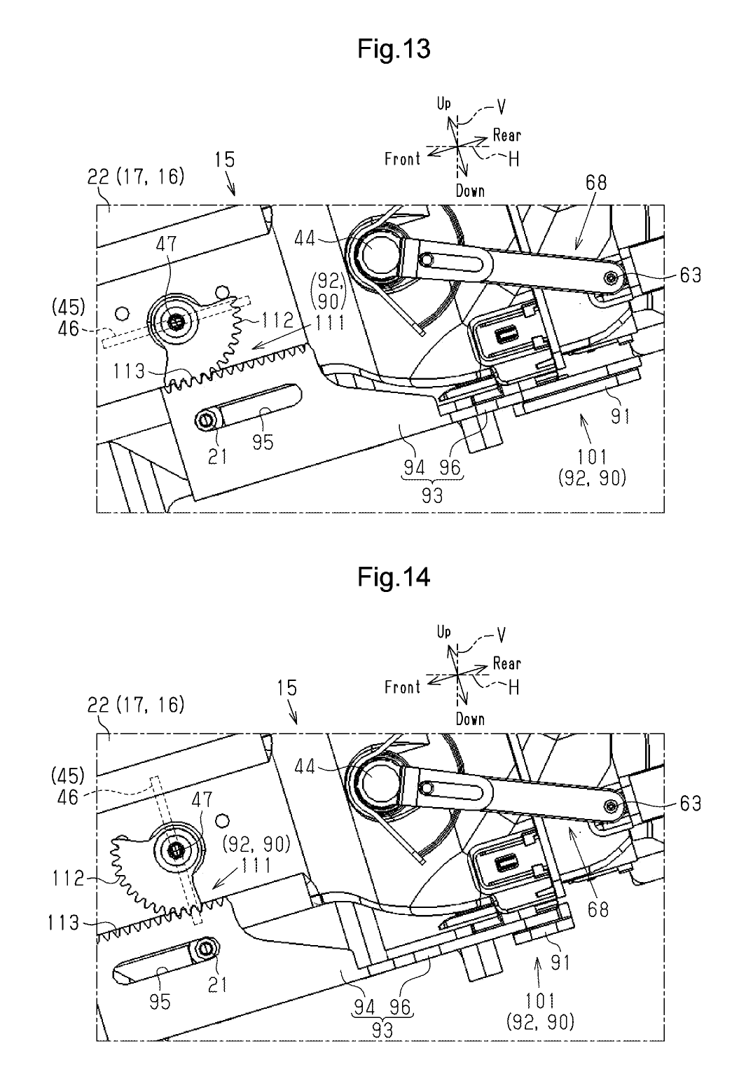

As shown in FIGS. 6 and 13, the vertical guide plate portion 94 has an elongated hole 95 extending in the front-rear direction. The guide pin 21, which protrudes leftward from the side wall 22, is engaged with the elongated hole 95.

As shown in FIGS. 6 and 10, the horizontal guide plate portion 96 has elongated holes 97 extending in the front-rear direction at multiple (three in the present embodiment) locations. The guide pins 24, which protrude downward from the lower wall 19, are respectively engaged with these elongated holes 97.

The elongated holes 95, 97 and the guide pins 21, 24 are each configured to guide movement of the guide plate 93 in the front-rear direction. The elongated holes 95, 97 and the guide pins 21, 24 are each configured to move the guide plate 93 in the front-rear direction between two positions that are spaced apart from each other in the front-rear direction. As shown in FIGS. 10 and 11, one of the two positions is where the guide pin 21 is located at the upstream end of each of the elongated holes 95, 97, and is hereinafter referred to as a standby position. As shown in FIG. 12, the other position is where the guide pin 21, 24 is located at the downstream end of the elongated hole 95, 97, and is hereinafter referred to as an active position.

### First Conversion Mechanism Portion 101

As shown in FIGS. 6 and 10-12, the first conversion mechanism portion 101 is provided on the guide plate 93 and the tilting portion 91 and convert tilting of the tilting portion 91 into linear movement of the guide plate 93.

The first conversion mechanism portion 101 includes a connecting pin 102 and a slit-shaped guide groove 103. The connecting pin 102 is provided at a position of the tilting portion 91 radially separated from the upstream fin shaft 54. In the present embodiment, the connecting pin 102 protrudes upward from the protruding end of the tilting portion 91.

The guide groove 103 is provided at the downstream end of the horizontal guide plate portion 96 of the guide plate 93. The guide groove 103 has a width that is slightly larger than the diameter of the connecting pin 102.

The guide groove 103 includes an inlet/outlet 104 and a groove body 105. The inlet/outlet 104 opens at a downstream end surface 96a of the horizontal guide plate portion 96. Further, the inlet/outlet 104 extends upstream from the downstream end surface 96a while being inclined with respect to the front-rear direction such that the inlet/outlet 104 is positioned progressively further to the left as it extends upstream. The groove body 105 extends in the leftward direction, which is one of the directions intersecting the front-rear direction, from the upstream end of the inlet/outlet 104.

The guide groove 103 is formed such that features including its position, shape, and size satisfy the following conditions.

When the tilting portion 91 passes through the second tilting position during tilting from the first tilting position to the third tilting position, the connecting pin 102 moves into the inlet/outlet 104 (see FIGS. 8 and 11).

When the tilting portion 91 passes through the second tilting position during tilting from the third tilting position to the first tilting position, the connecting pin 102 moves out of the inlet/outlet 104.

When the tilting portion 91 tilts between the second tilting position and the third tilting position, the connecting pin 102 moves in the left-right direction in the groove body 105, so that the tilting of the tilting portion 91 is converted into linear movement of the guide plate 93 (see FIGS. 11 and 12).

### Second Conversion Mechanism Portion 111

As shown in FIGS. 6 and 9, the second conversion mechanism portion 111 is provided in the guide plate 93 and the shut damper 45. The second conversion mechanism portion 111 converts linear movement of the guide plate 93 into rotation of the damper shaft 47.

The second conversion mechanism portion 111 includes a fan-shaped pinion gear 112 and a rack gear 113. The pinion gear 112 is attached to a portion of the damper shaft 47 protruding from the left side wall 22 so as to be integrally rotatable. The rack gear 113 is provided at the upper end of the vertical guide plate portion 94. The rack gear 113 includes teeth arranged in the front-rear direction. The rack gear 113 of the guide plate 93 is engaged with the pinion gear 112.

The second conversion mechanism portion 111 converts linear movement of the guide plate 93 into rotation of the damper shaft 47 by changing, in accordance with linear movement of the guide plate 93, an engagement position between the rack gear 113 and the pinion gear 112.

### OPERATION OF THE PRESENT EMBODIMENT

### Operation Knob 66 at Reference Position

FIGS. 4 and 5 each show a state of the air-conditioning register 15 when the operation knob 66 is positioned at the center of a range of left-right movement and at the center of a range of up-down movement. The position of the operation knob 66 in this state is referred to as a reference position.

In this state, as shown in FIGS. 10 and 13, the guide plate 93 is located at the standby position. At the standby position, each of the guide pins 21, 24 is located at the upstream end of a corresponding one of the elongated holes 95, 97. The tilting portion 91 is located at an intermediate position between the first tilting position and the second tilting position. At the intermediate position, the tilting portion 91 extends in the front-rear direction. The connecting pin 102 is separated from the guide groove 103 and located rightward from and downstream of the guide groove 103.

As shown in FIG. 6, the shut damper 45 is in the open position. In the open position, as shown in FIG. 3, the damper body 46 is parallel or substantially parallel to the upstream portions of the upper wall 18 and the lower wall 19, and thus creates a relatively large opening to the upstream passage portion 28 in the up-down direction.

When the distribution body 43 is parallel or substantially parallel to the upstream portions of the upper wall 18 and the lower wall 19, a relatively large opening is created to each of the body passage portions 31, 32.

As shown in FIGS. 3 and 4, the upstream fins 51 to 53 are all parallel or substantially parallel to the downstream portions of the side walls 22, 23. The upper upstream fin bodies 55 create a relatively large opening to the upper body passage portion 31, and the lower upstream fin bodies 56 create a relatively large opening to the lower body passage portion 32. The position of each upstream fin 51 in this state is referred to as a neutral position.

The downstream fin body 62 is parallel or substantially parallel to the downstream portions of the upper wall 18 and the lower wall 19. The downstream fin body 62 creates a relatively large opening to the lower body passage portion 32. The position of the downstream fin 61 in this state is referred to as a neutral position.

The conditioned air A1 that has flowed into the retainer 16 from the inlet 26 is distributed to the upper and lower sides of the shut damper 45 and the distribution body 43 when passing through the shut damper 45 and the distribution body 43.

The conditioned air A2 distributed to the upper body passage portion 31 flows downstream along the upstream fin body 55. Similarly, the conditioned air A3 distributed to the lower body passage portion 32 flows downstream along the upstream fin body 56.

As the conditioned air A2 flows through the downstream portion 31a of the body passage portion 31, the flow direction gradually shifts downward toward the downstream side. As the conditioned air A3 flows through the downstream portion 32a of the body passage portion 32, the flow direction gradually shifts upward toward the downstream side.

As shown in FIG. 4, the conditioned air A4 that has flowed into the connecting passage portion 33 flows along the inner wall surface of the side wall 22.

The conditioned air A2 that has flowed through the upper body passage portion 31, the conditioned air A3 that has flowed through the lower body passage portion 32, and the conditioned air A4 that has flowed through the connecting passage portion 33 meet and merge to form a single downstream flow.

The operation of the air-conditioning register 15 when the operation knob 66 is manipulated to change the discharge direction of the conditioned air A5 from the air outlet 35 will now be described.

### Application of Up-Down Directional Force to the Operation Knob 66

Referring to FIGS. 3 and 5, when an up-down directional force is applied to the operation knob 66 located at the reference position, this force is transmitted to the downstream fin 61. The downstream fin 61 at the neutral position is tilted about the two downstream fin shafts 63. The tilting is transmitted to the distribution member 41 via the linkage mechanism 68. In conjunction with the tilting of the downstream fin 61, the distribution body 43 vertically tilts about the rotating base 42.

The distribution member 41 changes the ratio between the conditioned air A2, which flows into the upper body passage portion 31 from the upstream passage portion 28, and the conditioned air A3, which flows into the lower body passage portion 32 from the upstream passage portion 28.

For example, when an upward force is applied to the operation knob 66, the downstream fin body 62 tilts so as to become higher toward the downstream side. The tilting is transmitted to the distribution member 41 via the linkage mechanism 68, so that the distribution body 43 tilts in a direction opposite to the downstream fin body 62.

When the distribution body 43 is tilted so as to become higher toward the upstream side, the flow of the conditioned air A1 from the upstream passage portion 28 into the upper body passage portion 31 is restricted by the distribution member 41. Accordingly, a smaller amount of the conditioned air A1 flows into the upper body passage portion 31, and a larger amount of the conditioned air A1 flows into the lower body passage portion 32.

The conditioned air A3 flows along the tilted downstream fin 61 while flowing through the lower body passage portion 32, so that the flow direction becomes higher toward the downstream side and changes to a direction corresponding to the tilting of the upstream fin body 55.

The amount of the conditioned air A2 flowing through the lower body passage portion 32 is larger than the amount of the conditioned air A3 flowing through the upper body passage portion 31. Thus, the flow direction after the conditioned air A2 and the conditioned air A3 meet is tilted so as to be higher toward the downstream side.

When the distribution body 43 tilts so as to become higher toward the upstream side contacts or closely approaches the upper wall 18, the upper body passage portion 31 closes. The conditioned air A1 flowing through the upstream passage portion 28 is restricted from flowing into the upper body passage portion 31. As a result, the conditioned air A1 flows into the lower body passage portion 32 and the connecting passage portion 33.

### Application of Left-Right Directional Force to the Operation Knob 66

When the operation knob 66 is slid from the reference position toward one side in the left-right direction, for example, toward the left side, as shown in FIGS. 7 and 8, the sliding is transmitted to the two upstream fins 52 located at the neutral position via the first transmission mechanism 84. That is, along with the sliding, the first rib 85 of the operation knob 66 moves leftward. The second rib 86 is pushed leftward by the first rib 85, thereby applying a leftward force to the rod 79. The rod 79 moves leftward together with the connecting shaft 76 of each upstream fin 52.

The movement of the rod 79 is transmitted to the upstream fins 52 via the two connecting shafts 76. The two upstream fins 52 are tilted about their upstream fin shafts 54. The tilting is transmitted to the other upstream fins 51, 53 via the link mechanism LM. Accordingly, all of the upstream fins 51 to 53 are synchronously tilted from the neutral position about their respective upstream fin shafts 54. When the conditioned air A2 and A3 flow downstream along the upstream fin bodies 55 and 56, the flow direction is changed obliquely leftward, and the conditioned air A5 is discharged from the air outlet 35.

As the upstream fin 51 tilts, the tilting portion 91 tilts integrally with the upstream fin 51 about its upstream fin shaft 54. The tilting causes the tilting portion 91 to approach the guide plate 93 located at the standby position. The tilting of the tilting portion 91 is not transmitted to the guide plate 93. The position where the rack gear 113 is engaged with the pinion gear 112 remains unchanged. Thus, the shut damper 45 remains in the open position.

When the operation knob 66 is slid further leftward from the above state, each of the upstream fins 51 to 53 tilts further in a direction that closes the body passage portions 31, 32. The discharge direction of the conditioned air A5 from the air outlet 35 shifts further leftward by a larger amount.

As shown in FIGS. 8 and 11, when the tilting portion 91 passes through the second tilting position during tilting from the first tilting position to the third tilting position, the connecting pin 102 moves into the inlet/outlet 104 of the guide groove 103. The conversion mechanism portion 92 switches from the state in which tilting of the tilting portion 91 is not converted into tilting of the shut damper 45 to the state in which the tilting is converted into tilting of the shut damper 45. In this state, the guide plate 93 remains stationary, and the engagement position between the rack gear 113 and the pinion gear 112 remains unchanged. Thus, the shut damper 45 remains in the open position.

In this manner, when the tilting portion 91 tilts between the first tilting position and the second tilting position in conjunction with the operation knob 66, the upstream fins 51 to 53 tilt. However, the conversion mechanism portion 92 does not convert the tilting of the tilting portion 91 into tilting of the shut damper 45.

When the operation knob 66 is slid further leftward so that the tilting portion 91 tilts from the second tilting position toward the third tilting position, each of the upstream fins 51 to 53 tilts further in the direction that closes the body passage portions 31, 32. The discharge direction of the conditioned air A5 from the air outlet 35 shifts further leftward by a larger amount.

Further, in this state, the conversion mechanism portion 92 converts the tilting of the tilting portion 91 into tilting of the shut damper 45. That is, when the tilting portion 91 is tilted by operating the operation knob 66, the tilting is converted into linear movement in the front-rear direction by the first conversion mechanism portion 101 and is transmitted to the guide plate 93.

In the present embodiment, as the upstream fin 51 tilts, the connecting pin 102 moves upstream along an arc centered on the upstream fin shaft 54. The connecting pin 102 is moved leftward in the groove body 105. Tilting of the tilting portion 91 is converted into linear movement by the connecting pin 102 and the guide groove 103 and transmitted to the guide plate 93. The guide plate 93 moves upstream while being guided by the elongated holes 95, 97 and the guide pins 21, 24.

When the guide plate 93 moves linearly, the linear movement is converted into rotation by the second conversion mechanism portion 111 and is transmitted to the damper shaft 47. The shut damper 45 tilts about the damper shaft 47. That is, as the guide plate 93 moves linearly, the engagement position of the rack gear 113 with the pinion gear 112 changes, and the pinion gear 112 rotates integrally with the damper shaft 47. The shut damper 45 tilts about the damper shaft 47 in the direction that closes the upstream passage portion 28. This reduces the amount of the conditioned air A2 to A4 flowing downstream of the damper body 46 in the passage 27.

As shown in FIGS. 9 and 12, when the tilting portion 91 tilts to the third tilting position, the guide plate 93 moves to the active position. The connecting pin 102 moves to the left end of the groove body 105 in the guide groove 103.

The upper body passage portion 31 is closed by the upper upstream fin bodies 55, and the lower body passage portion 32 is closed by the lower upstream fin bodies 56. Further, the upstream passage portion 28 is closed by the damper body 46. The passage 27 is closed by the shut damper 45 and the upstream fins 51 to 53. The conditioned air A1 fails to pass through the damper body 46 and is thus restricted from flowing downstream of the damper body 46. The conditioned air A4 no longer flows through the connecting passage portion 33. The conditioned air A1 to A4 is less likely to flow through the passage 27, compared to when the passage 27 is closed only by the upstream fins 51 to 53.

Thus, in addition to the upstream fins 51 to 53, the shut damper 45 also tilts. In other words, when the operation knob 66 is operated to change the orientations of the upstream fins 51 to 53, the shut damper 45 is also tilted. This eliminates the need to perform, for tilting the shut damper 45, an operation on the operation knob 66 that is different from an operation for changing the orientations of the upstream fins 51 to 53.

When the operation knob 66 is slid rightward from the above state, the components operate in a manner opposite to that described above.

Specifically, as the operation knob 66 is slid rightward, the tilting portion 91 is tilted from the third tilting position toward the second tilting position. Each of the upstream fins 51 to 53 tilts to a direction that opens the body passage portions 31, 32. The discharge direction of the conditioned air A5 from the air outlet 35 changes.

During the change, the conversion mechanism portion 92 converts the tilting of the tilting portion 91 into tilting of the shut damper 45. As the upstream fins 51 to 53 tilt, the tilting portion 91 tilts about the upstream fin shaft 54 in the same direction as the upstream fin bodies 55, 56. The position of the connecting pin 102 in the guide groove 103 changes rightward. The tilting of the tilting portion 91 is transmitted to the guide plate 93 via the connecting pin 102 and the guide groove 103. The guide plate 93 moves downstream while being guided by the elongated holes 95, 97 and the guide pins 21, 24. This movement changes the engagement position of the rack gear 113 with the pinion gear 112. When the pinion gear 112 pivots integrally with the damper shaft 47, the shut damper 45 tilts from the closed position toward the open position. Thus, a larger amount of the conditioned air A2 to A4 flows downstream of the damper body 46 in the passage 27.

The conditioned air A2 to A4 that has passed through the shut damper 45 flows along the tilted upstream fins 51 to 53. The conditioned air A2, A3 is discharged from the air outlet 35 in the left direction, in which the upstream fins 51 to 53 are tilted.

In this manner, when the operation knob 66 is operated to change the orientations of the upstream fins 51 to 53, the shut damper 45 is also tilted. This eliminates the need to perform, for tilting the shut damper 45, an operation on the operation knob 66 that is different from an operation for changing the orientations of the upstream fins 51 to 53.

As shown in FIGS. 8 and 11, when the tilting portion 91 passes through the second tilting position during tilting from the third tilting position to the first tilting position, the shut damper 45 moves to the open position and the connecting pin 102 moves out of the inlet/outlet 104 of the guide groove 103. The conversion mechanism portion 92 switches from the state in which tilting of the tilting portion 91 is converted into tilting of the shut damper 45 to the state in which the tilting is not converted into tilting of the shut damper 45.

When the tilting portion 91 tilts between the second tilting position and the first tilting position, the conversion mechanism portion 92 does not convert tilting of the tilting portion 91 into tilting of the shut damper 45. The shut damper 45 remains in the open position. In contrast, the upstream fins 51 to 53 tilt. Thus, the conditioned air A1 that has flowed into the retainer 16 passes through the shut damper 45 and then flows along the upstream fins 51 to 53. The conditioned air A5 is discharged from the air outlet 35 in a direction in which the upstream fin bodies 55, 56 face.

When the operation knob 66 is slid further rightward, the damper body 46 is maintained in the open position. Each of the upstream fins 51 to 53 and the tilting portion 91 continues to tilt.

As shown in FIGS. 6 and 10, during tilting of the tilting portion 91 from the second tilting position toward the first tilting position, the operation knob 66 returns to the reference position. At the reference position, the tilting portion 91 is located at an intermediate position between the first tilting position and the second tilting position. As described above, the shut damper 45 is in the open position, and each of the upstream fins 51 to 53 is in the neutral position.

When the operation knob 66 at the reference position is slid rightward, the components of the air-conditioning register 15 operate in a manner opposite to those performed when the operation knob 66 is slid leftward. That is, the upstream fins 51 to 53 are synchronously tilted about their respective upstream fin shafts 54 in a direction opposite to that when the operation knob 66 is slid leftward.

The conversion mechanism portion 92 does not convert the tilting of the tilting portion 91 into tilting of the shut damper 45. Since the connecting pin 102 moves outside the guide groove 103, the tilting of the tilting portion 91 is not transmitted to the guide plate 93. The damper body 46 is maintained in the open position.

When the tilting portion 91 is in the first tilting position as indicated by the double-dashed line in FIG. 10, the shut damper 45 is in the open position. This causes the upstream fins 51 to 53 to open the passage 27.

The conditioned air A1 that has flowed into the upstream passage portion 28 passes through the damper body 46. Then, the conditioned air A1 flows downstream along the upstream fin bodies 55, 56. The conditioned air A5 is discharged in the direction in which the upstream fin bodies 55, 56 face. That is, the conditioned air A5 is discharged from the air outlet 35 with its flow direction changed obliquely rightward.

### ADVANTAGES OF THE PRESENT EMBODIMENT

(1) As shown in FIGS. 6, 8, and 9, in the present embodiment, the upstream fins 51 to 53 and the shut damper 45 are both tilted by operating the operation knob 66.

Accordingly, unlike when a member operated to tilt the upstream fins 51 to 53 and a member such as an operation dial operated to tilt the shut damper 45 are separately provided, the number of members to be operated is only one. This reduces the number of components of the air-conditioning register 15. This also improves the appearance of the air-conditioning register 15.

(2) The air-conditioning register 15 includes the upstream fins 51 to 53, which tilt in response to operation of the operation knob 66, and the shut damper 45. In the air-conditioning register 15, tilting of the upstream fins 51 to 53 is transmitted to the shut damper 45 by the second transmission mechanism 90. The tilting portion 91 of the second transmission mechanism 90 tilts together with the upstream fins 51 to 53 between the first tilting position and the third tilting position, with the second tilting position interposed therebetween, in conjunction with movement of the operation knob 66 in the operation direction. The conversion mechanism portion 92 of the second transmission mechanism 90 converts tilting of the tilting portion 91 into tilting of the shut damper 45 only when the tilting portion 91 tilts between the second tilting position and the third tilting position.

Thus, when the operation knob 66 is operated to change the orientations of the upstream fins 51 to 53, the shut damper 45 is also tilted. This eliminates the need to perform, for tilting the shut damper 45, an operation on the operation knob 66 that is different from an operation for changing the orientations of the upstream fins 51 to 53. As a result, the operability of the operation knob 66 is improved.

(3) As shown in FIGS. 9 and 12, the tilting portion 91 is configured to be in the third tilting position when the upstream fins 51 to 53 close the passage 27. As shown in FIGS. 8 and 11, when the tilting portion 91 is in the second tilting position, the conversion mechanism portion 92 places the shut damper 45 in the open position. As shown in FIGS. 9 and 12, when the tilting portion 91 is in the third tilting position, the conversion mechanism portion 92 places the shut damper 45 in the closed position. When the tilting portion 91 tilts between the second tilting position and the third tilting position, the conversion mechanism portion 92 converts the tilting into tilting of the shut damper 45.

Thus, when the tilting portion 91 is tilted from the second tilting position toward the third tilting position by operating the operation knob 66, the upstream fins 51 to 53 and the shut damper 45 are tilted in the direction that closes the passage 27.

When the tilting portion 91 is tilted to the third tilting position, the upstream fins 51 to 53 close the passage 27, and the shut damper 45 closes the passage 27. That is, the passage 27 is closed by both the shut damper 45 and the upstream fins 51 to 53.

Thus, as compared to closure of the passage 27 only by the upstream fins 51 to 53, the conditioned air A1 to A4 is blocked more effectively.

(4) Further, in connection with (3), in general, when a passage is closed only by upstream fins, blockage of conditioned air A1 to A4 tends to be less effective than when the passage is closed by a shut damper, due to factors including dimensional tolerances of components and assembly tolerances. In contrast, improving blockage by manufacturing components with higher precision leads to increased cost.

In the present embodiment, the passage 27 is closed by the shut damper 45 in addition to the upstream fins 51 to 53.

This allows the conditioned air A1 to A4 to be more effectively blocked without increasing cost.

(5) As shown in FIG. 6, the conversion mechanism portion 92 includes the guide plate 93, the first conversion mechanism portion 101, and the second conversion mechanism portion 111.

This allows the first conversion mechanism portion 101 to convert tilting of the tilting portion 91 into linear movement of the guide plate 93, and allows the second conversion mechanism portion 111 to convert the linear movement into rotation of the damper shaft 47.

(6) As shown in FIGS. 6 and 10, the first conversion mechanism portion 101 includes the connecting pin 102 and the guide groove 103, which includes the inlet/outlet 104 and the groove body 105.

Accordingly, when the tilting portion 91 passes through the second tilting position while tilting from the first tilting position to the third tilting position or vice versa, the connecting pin 102 moves into or out of the inlet/outlet 104. In addition, when the tilting portion 91 tilts between the second tilting position and the third tilting position, tilting of the tilting portion 91 is converted into linear movement by moving the connecting pin 102 in the groove body 105. This conversion allows the guide plate 93 to linearly move in the front-rear direction.

### MODIFICATIONS

The present embodiment may be modified as follows. The present embodiment and the following modifications can be combined as long as the combined modifications remain technically consistent with each other.

The passage 27 may have a configuration different from that of the above embodiment. For example, the downstream passage portion 29 may include a single passage portion that does not branch into the body passage portions 31, 32 and the connecting passage portion 33. In addition, the downstream passage portion 29 does not have to include the connecting passage portion 33 and may only include the body passage portions 31, 32.

The air-conditioning register 15 may include a resistance-applying portion that applies resistance to at least one of the tilting portion 91 and the conversion mechanism portion 92 of the second transmission mechanism 90.

For example, the shims 36 may be formed of an elastic material, and the upstream fin shafts 54 may be press-fitted into bearing holes of the shims 36. In this modification, the shims 36 are elastically deformed to apply resistance to the upstream fin shafts 54. Thus, when an external force is applied to the second transmission mechanism 90, the upstream fins 51 to 53 are prevented from tilting about the upstream fin shafts 54. The tilt of the upstream fin bodies 55, 56 is prevented from being changed by an external force. This modification also reduces changes in the inclination of the damper body 46 caused by movement of the guide plate 93 that results from an external force.

Further, in the shims 36, ring members formed of an elastic material such as rubber may be interposed, as resistance-applying portions, between bearing holes that support the upstream fin shafts 54 and the upstream fin shafts 54. In this modification, the ring members apply resistance to the upstream fin shafts 54. Accordingly, in this case, when an external force is applied to the second transmission mechanism 90, the upstream fins 51 to 53 are prevented from tilting about the upstream fin shafts 54.

Further, a damper such as a rotary damper may be used as the resistance-applying portion, and, for example, resistance may be applied to the damper shaft 47. The rotary damper includes a housing, a rotor rotatably accommodated in the housing, and a shaft rotatably coupled to the rotor so as to rotate integrally with the rotor. The housing contains a liquid viscous fluid, such as oil, between the housing and the rotor. The shaft is coupled to the damper shaft 47 so as to be integrally rotatable. The rotary damper generates torque during rotation of the rotor and the shaft due to viscous resistance of the viscous fluid. By this torque, the rotary damper applies rotational resistance to the damper shaft 47.

Accordingly, in this case, when an external force is applied to the second transmission mechanism 90, the upstream fins 51 to 53 are prevented from tilting about the upstream fin shafts 54.

The air-conditioning register 15 may be incorporated in a location in the vehicle interior other than the instrument panel 11, such as a dashboard.

The air-conditioning register 15 is broadly applicable as an air-conditioning register for fields other than vehicles, provided that it includes a shut damper 45 that opens and closes the passage 27 in addition to changing the direction of the conditioned air A5 discharged from the air outlet 35.

The air outlet 35 of the air-conditioning register 15 may be vertically elongated. In this case, upstream fins 51 to 53 each having an upstream fin shaft 54 that extends in the left-right direction are used, and the upstream fins 51 to 53 are arranged in the up-down direction. Further, a shut damper 45 having a damper shaft 47 that extends in the up-down direction is used.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An air-conditioning register, comprising:
a retainer including a passage for conditioned air, the passage including an air outlet at a downstream end of the passage;
a shut damper including a damper body disposed in the retainer and a damper shaft supported by the retainer and supporting the damper body, the damper body being configured to tilt about the damper shaft between an open position in which the passage is opened and a closed position in which the passage is closed;
fins, each including a fin body disposed in the retainer and downstream of the damper body in the passage and a fin shaft supported by the retainer and supporting the fin body, the fin being configured to change a flow direction of the conditioned air by the fin body tilting about the fin shaft;
an operation knob configured to be operated to tilt the fins; and
a transmission mechanism configured to transmit tilting of the fins to the shut damper, wherein
the transmission mechanism includes:
a tilting portion configured to tilt together with the fins in conjunction with movement of the operation knob in an operating direction of the operation knob between a first tilting position and a third tilting position, with a second tilting position interposed therebetween; and
a conversion mechanism portion configured to convert tilting of the tilting portion into tilting of the shut damper only when the tilting portion tilts between the second tilting position and the third tilting position.

2. The air-conditioning register according to claim 1, wherein
the fins are configured to close the passage,
the tilting portion is configured to be in the third tilting position when the fins close the passage,
the conversion mechanism portion is configured to place the shut damper in the open position when the tilting portion is in the first tilting position, and place the shut damper in the closed position when the tilting portion is in the third tilting position,
the conversion mechanism portion is configured to convert tilting of the tilting portion into tilting of the shut damper when the tilting portion tilts between the second tilting position and the third tilting position,
the conversion mechanism portion is configured to switch, when the tilting portion passes through the second tilting position during tilting from the first tilting position to the third tilting position, from a state in which tilting of the tilting portion is not converted into tilting of the shut damper to a state in which tilting of the tilting portion is converted into tilting of the shut damper, and
the conversion mechanism portion is configured to switch, when the tilting portion passes through the second tilting position during tilting from the third tilting position to the first tilting position, from the state in which tilting of the tilting portion is converted into tilting of the shut damper to the state in which tilting of the tilting portion is not converted into tilting of the shut damper.

3. The air-conditioning register according to claim 1, wherein
the conversion mechanism portion includes:
a guide plate disposed between the damper shaft and the tilting portion to be linearly movable in a direction in which the passage extends;
a first conversion mechanism portion provided on the guide plate and the tilting portion and configured to convert tilting of the tilting portion between the second tilting position and the third tilting position into linear movement of the guide plate; and
a second conversion mechanism portion provided on the guide plate and the shut damper and configured to convert linear movement of the guide plate into rotation of the damper shaft.

4. The air-conditioning register according to claim 3, wherein
the tilting portion is attached to the fin shaft so as to be integrally rotatable,
the first conversion mechanism portion includes a connecting pin provided at a position of the tilting portion radially spaced apart from the fin shaft, and a guide groove which is disposed in the guide plate and with which the connecting pin is movably engaged,
the guide groove includes an inlet/outlet that opens at a downstream end surface of the guide plate, and a groove body that extends from an upstream end of the inlet/outlet in a direction intersecting the direction in which the passage extends,
the first conversion mechanism portion is configured to move the connecting pin into the inlet/outlet when the tilting portion passes through the second tilting position during tilting from the first tilting position to the third tilting position,
the first conversion mechanism portion is configured to move the connecting pin out of the inlet/outlet when the tilting portion passes through the second tilting position during tilting from the third tilting position to the first tilting position, and
the first conversion mechanism portion is configured to convert tilting of the tilting portion into linear movement of the guide plate by moving the connecting pin in the groove body when the tilting portion tilts between the second tilting position and the third tilting
position.
